(19) United States
(12) Patent Application Publication
(10) Pub. No.: US 2003/0042293 A1
(43) Pub. Date: Mar. 6, 2003

(54) Friction stir welding method and panel structure for friction stir welding

(76) Inventors: Masakuni Ezumi, Houfu (JP); Kazushige Fukuyori, Kudamatsu (JP); Hisanori Okamura, Naka-gun (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/066,674

(22) Filed: Feb. 6, 2002

(30) Foreign Application Priority Data
Sep. 3, 2001 (JP) 2001-265338

(51) Int. Cl. B23K 20/12; B23K 31/02

(52) U.S. Cl. 228/112.1; 228/2.1

(57) ABSTRACT

Face plates 11b and 12b of a hollow shape member 10 are abutted against face plates 21b and 22b of a hollow shape member 20. Projections 15, 16, 25 and 26 are formed to both sides of the face plates at the abutted areas. The rotary tool 50 comprises two large-diameter portions 53 and 54, and a small-diameter portion 51 disposed therebetween. The projections 15, 16, 25 and 26 of the portions 11b and 21b (12b and 22b) to be welded are sandwiched between the two large-diameter portions 53 and 54 upon performing the friction stir welding. According thereto, even if the heights of the abutted areas of the plates against the two large-diameter portions 53 and 54 differ, the face plates 11b and 21b (12b and 22b) will not be damaged (cut) by the tool since only the depth of the large-diameter portion being inserted to the projections varies. Therefore, the welding process will not reduce the thickness of the face plates, leading to design-related and function-related problems.

### FIELD OF THE INVENTION

The present invention relates to a friction stir welding method that is especially preferable for welding hollow shape members constituting a railway car.

### DESCRIPTION OF THE RELATED ART

Friction stir welding is a method performed by inserting a rotating round shaft (called a rotary tool) to a joint region between members to be welded, and moving the same along the joint line, thereby heating, softening, plasticizing, and solid-phase welding the joint region. The rotary tool comprises a large-diameter portion and a small-diameter portion. The small-diameter portion is inserted to the members to be welded, and the end surface of the large-diameter portion is disposed so as to contact the members. The method is disclosed in Japanese Patent No. 2712838 (U.S. Pat. No. 5,460,317), Japanese Patent Laid-Open Publications No. 10-216964 (216964/98), No. 2000-334580 (EP 1057574A2), No. 2001-047262 (EP 1057575A2), and No. 2001-150156 (EP 1103334 A2).

During the friction stir welding, a large force is applied to insert the rotary tool to the members to be welded. This force acts on the rotary tool, the members being welded, and the bed supporting the members. Therefore, these members must each have strength strong enough to support such force.

Upon friction stir welding two hollow shape members, the area of one hollow shape member where a connecting plate for connecting the two face plates exists is selected as the friction stir welding position, at which the member is welded with the other hollow shape member. In this example, the connecting plate is used to support the above-mentioned force, thereby preventing deformation of hollow shape members during the friction stir welding. Of course, the bed is also strong enough to support such force. This technique is disclosed in Japanese Patent Laid-Open Publication No. 2000-334580 (EP 1057574 A2).

Another conventional friction stir welding technique involves placing the members being welded between the two large-diameter portions of a rotary tool. This technique advantageously cuts down the cost related to the bed. This art is disclosed in Japanese Patent No. 2712838 (U.S. Pat. No. 5,460,317).

### SUMMARY OF THE INVENTION

As mentioned above, the cost of the bed can be cut down by placing the members to be welded between the two large-diameter portions of a rotary tool upon performing the friction stir welding. The application of such method to welding hollow shape members can also reduce the cost of the hollow shape members.

However, this brings about many problems, since the bed cannot support the welding region even when the hollow shape members being welded is placed on the bed.

For example, the members to be welded are sometimes positioned above or below the predetermined weld position (the position of the large-diameter portions of the rotary tool). When the area to be welded is positioned above the predetermined weld position, the upper surface of the members is shaved by the upper large-diameter portion. On the other hand, when the area to be welded is positioned below the predetermined weld position, the lower surface of the members is shaved by the lower large-diameter portion. This results in reduced plate thickness of the hollow shape members, leading to insufficient strength thereof. Therefore, it was necessary to thicken the plate thickness at the joint region so as to compensate for the surface material being shaved off, which increased the total weight of the members.

If the shaved surface is disposed as the outer surface of the railway car body, the appearance becomes a problem. If the surface is to be smoothed by applying a coating thereto, a large amount of putty must be used. The same problem occurs when using the welded members to form a container and the like where a smooth surface is required.

A similar problem occurs when only a part of the thickened plate is shaved, and a dent is formed on the surface.

Therefore, the object of the present invention is to provide a good weld upon friction stir welding members using a rotary tool having two large-diameter portions.

The second object of the present invention is to provide an easy friction stir welding technique upon friction stir welding long plates.

The third object of the present invention is to provide a good friction stir weld by accurately guiding the rotary tool to the portion to be friction stir welded.

The above object of the present invention is achieved by a friction stir welding method comprising abutting an end of a first plate against an end of a second plate; wherein upon abutment, projections are disposed on both surfaces of said abutted portion, constituted either by said end of said first plate, said end of said second plate, or both said ends of said first and second plates; and rotating and moving a rotary tool having two large-diameter portions provided to both ends of a small-diameter portion along said abutted portion with said projections on both surfaces sandwiched between said two large-diameter portions of said rotary tool.

Moreover, the above object is achieved by a friction stir welding method comprising: abutting two face plates of a first hollow shape member against two face plates of a second hollow shape member, respectively; wherein upon abutment, projections are disposed on both surfaces of said abutted portions, constituted either by said ends of each face plate of said first hollow shape member, by said ends of each face plate of said second hollow shape member, or by both; and rotating and moving a rotary tool having two large-diameter portions provided to both ends of a small-diameter portion along said abutted portion with said projections on both surfaces sandwiched between said two large-diameter portions of said rotary tool, with either one side or both sides of said hollow shape members being subject to welding.

The above object is achieved by a friction stir welding method comprising: abutting a first face plate of a first hollow shape member against a first face plate of a second hollow shape member, respectively; wherein upon abutment, projections are disposed on both surfaces of said abutted portion, constituted either by said end of the face plate of said first hollow shape member, by said end of the face plate of said second hollow shape member, or by both; rotating and moving a rotary tool having two large-diameter portions provided to both ends of a small-diameter portion along said abutted portion with said projections on both surfaces sandwiched between said two large-diameter portions of said rotary tool; superposing a connecting member on and abutting the same against a second face plate of said first hollow shape member and a second face plate of said second hollow shape member; wherein upon abutment, projections are disposed on both surfaces of the abutted portion, constituted either by said end of the second face plate of said first hollow shape member, by an end of said connecting member, or by both; wherein upon abutment, projections are disposed on both surfaces of the abutted portion, constituted either by said end of the second face plate of said second hollow member, by an end of said connecting member, or by both; and rotating and moving a rotary tool having two large-diameter portions provided to both ends of a small-diameter portion along said abutted portion with said projections on both surfaces sandwiched between said two large-diameter portions of said rotary tool, with either the abutted portion between said first hollow shape member and said connecting member, or both the abutted portion between said first hollow shape member and said connecting member and the abutted portion between said second hollow shape member and said connecting member being subject to welding.

The second object of the present invention is achieved by a friction stir welding method comprising: abutting a first face plate of a first hollow shape member against a first face plate of a second hollow shape member; friction stir welding said abutted region from a second face plate side; superposing a plurality of connecting members shorter than said first and second hollow shape members to a second face plate of said first hollow shape member and a second face plate of said second hollow shape member along said first and second hollow shape members; and welding the first hollow shape member and the connecting member, and friction stir welding the second hollow shape member and said connecting member.

The third object of the present invention is achieved by a friction stir welding method comprising: abutting the end of a first plate against the end of a second plate; wherein upon abutment, a projection is disposed on one surface of said abutted portion, constituted either by the end of said first plate, by the end of said second plate, or by both, said projection including a second projection; and detecting said second projection and guiding an inserted rotary tool to said abutted portion.

### BRIEF DESCRIPTION OF THE DRAWINGS

FIG. 1 is a vertical cross-sectional view showing a pair of hollow shape members according to one embodiment of the present invention;

FIG. 2 is an enlarged vertical cross-sectional view showing the joint portion of the pair of hollow shape members of FIG.

FIG. 3 is a vertical cross-sectional view showing the main portion of the joint of FIG. 1 during welding;

FIG. 4 is a vertical cross-sectional view showing the main portion of the joint of FIG. 1 after the welding;

FIG. 5 is an exploded vertical cross-sectional view showing the rotary tool of FIG. 1;

FIG. 6 is a perspective view of the car body of the railway car;

FIG. 7 is a vertical cross-sectional view showing the main portion of another embodiment of the present invention;

FIG. 8 is a vertical cross-sectional view showing the main portion of yet another embodiment of the present invention;

FIG. 9 is a vertical cross-sectional view showing a pair of hollow shape members according to another embodiment of the present invention;

FIG. 10 is a vertical cross-sectional view showing the main portion of FIG. 9;

FIG. 11 is a vertical cross-sectional view showing the main portion of another embodiment of the present invention; and

FIG. 12 is a vertical cross-sectional view showing the main portion of yet another embodiment of the present invention.

### DETAILED DESCRIPTION OF THE PREFERRED EMBODIMENT

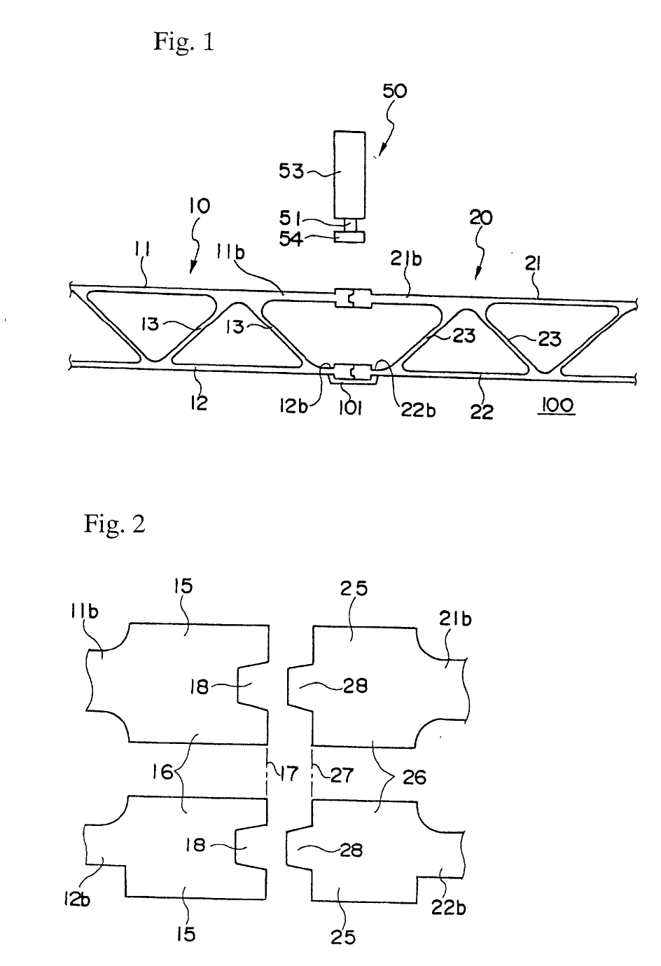

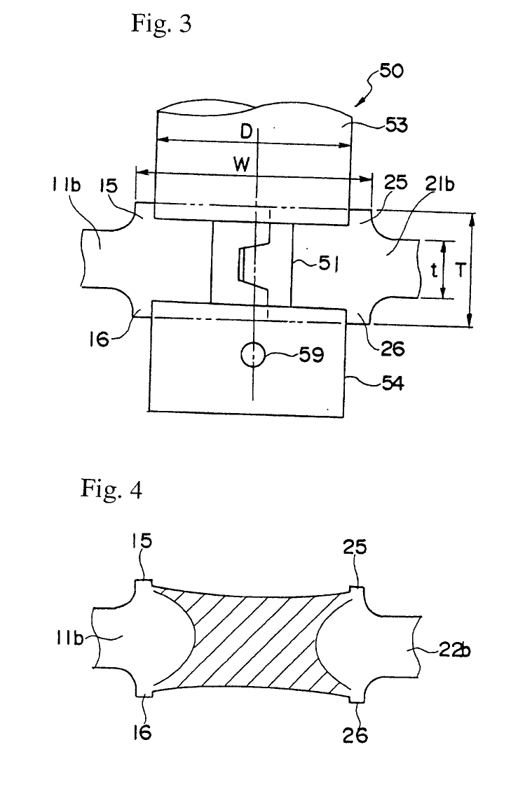

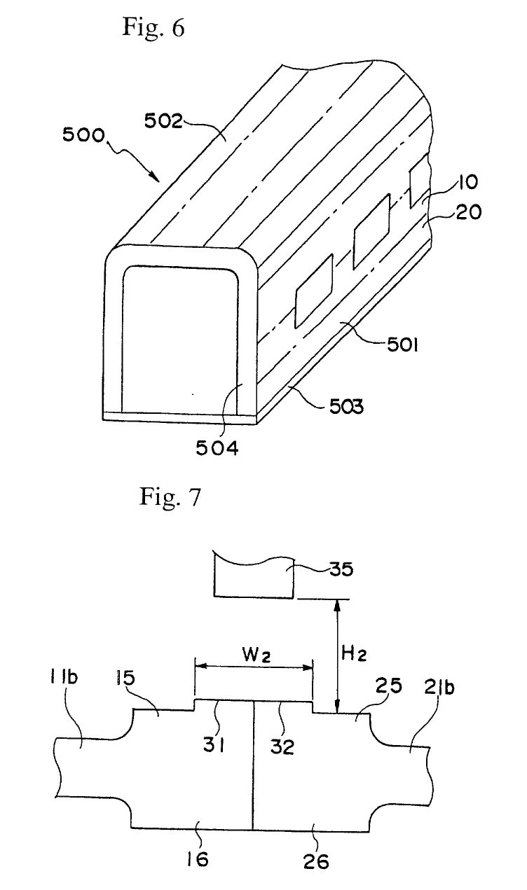

FIGS. 1 through 6 are referred to in explaining an embodiment of the present invention. FIG. 3 is a cross-sectional view showing the rotary tool along the central axis thereof. FIG. 4 is a cross-sectional view showing the hollow shape members along the thickness direction thereof. FIG. 4 shows a frame format of the shape of the weld region and the friction stir region shown by hatching.

A car body 500 of a railway car comprises side structures 501 that constitute the side walls thereof, a roof structure 502 that constitutes the roof thereof, an underframe 503 that constitutes the floor thereof, and end structures 504 that define the longitudinal ends thereof. The side structures 501, the roof structure 502, and the underframe 503 are each formed by welding plural extruded members 10, 20. The longitudinal direction (extruded direction) of the extruded members 10 and 20 is oriented along the longitudinal direction of the car body 500. The extruded members 10 and 20 are hollow shape members made of aluminum alloy.

The construction of the hollow shape members 10 and 20 that constitute the side structure 501 will now be explained. The construction of hollow shape members constituting the other areas is similar.

The hollow shape member 10 (20) comprises two substantially parallel face plates 11 (21) and 12 (22), and plural connecting plates 13 (23) that connect the two face plates. The connecting plates 13 (23) are sloped against the face plates 11 (21) and 12 (22). In other words, the face plates 11 (21) and 12 (22) and the connecting plates 13 (23) are arranged in trusses. The term “substantially parallel” includes the case where the face plate 11 (21) is sloped against the face plate 12 (22).

The width-direction-end of the hollow shape member 10 (20) comprises face plates 11b and 12b (21b and 22b) that are protruded than the connection between the connecting plates 13 (23) and the face plates 11 and 12 (21 and 22). The outer surface of the face plates 11b and 12b (21b and 22b) are flush with the outer surface of the face plates 11 and 12 (21 and 22). The plate thickness of the face plates 11b and 21b is thicker than the plate thickness of the face plates 11 and 21.

Projections 15 and 16 (25, 26) that protrude in the thickness direction (at both surfaces) are formed at the end of the face plates 11b and 12b (21b, 22b), respectively. The end surface of each face plate 11b and 12b is equipped with a recessed portion 18. On the corresponding end surfaces of face plates 21b and 22b of the other hollow shape member 20 is each formed a projection 28 that can be inserted to the recessed portion 18. In order to facilitate insertion of the projection 28 to the recessed portion 18, the recessed portion 18 and the projection 28 are each formed to have a trapezoidal shape. The recessed portion 18 and the projection 28 have substantially similar shapes. When inserted, a small gap is formed between the bottom surface of the recessed portion 18 and the protruded end of the projection 28. The size (depth, etc.) of the two recessed portions 18, 18 is the same. The size (protruded height, etc.) of the two projections 28, 28 is also the same.

A part of the upper and lower areas of the recessed portion 18 and the projection 28 can be formed within the thickness range of the projections 15, 16, 25, and 26. Therefore, even if the plate thickness of the face plates 11b, 12b, 21b, and 22b is thin, the recessed portions 18 and the projections 28 can be formed with a sufficiently large size.

The bottom surface of the recessed portion 18 refers to the bottom surface in the direction of depth of the recess, which opposes to the protruded end (apex) of the projection 28. The recessed portions 18 and the projections 28 can also be designed as a concave/convex shape other than the present trapezoidal shape.

The area including the recessed portion 18 and the projection 28 is friction stir welded with the projection 28 inserted to the recessed portion 18. Each end surface 17 (27) of the face plates 11b and 12b (21b, 22b) of the hollow shape member 10 is disposed along a line orthogonal to the surface of the face plates 11b and 12b (the line along the thickness direction of the hollow shape member). The two end surfaces 17 (27) are substantially disposed along the same line. The bottom surface of the recessed portion 18 and the protruded end of the projection 28 are substantially orthogonal to the face plates 11b and 12b.

The length of the face plates 11b and 21b extending from the connecting plate 13 disposed at one end of the hollow shape member 10 to the connecting plate 23 at the end of the other hollow shape member is longer than the length of the area of the face plates 11 and 21 at the other portions that constitute the trusses. Therefore, the face plates 11b and 21b are designed to have a thickness somewhat thicker than the other regions.

Since the length of the face plates 12b, 22b is short, the whole upper area of the face plates 12b, 22b can be set to the height of the projections 16, 26 so as to facilitate productivity of the members 10, 20.

The lines connecting the apex of the projections 16, 25 of the face plates 12b, 22b and the inner surface of the face plates 12b, 22b, and the lines connecting the apex of the projections 15, 25, 16, 26 of the face plates 11b, 21b and the face plates 11b, 21b, are all arced. The arc should preferably be as large as possible. However, the lines connecting the apex of the projections 15, 25 of the face plates 12b, 22b and the outer surface of the face plates 12b, 22b are linearly orthogonal to the face plates 12b, 22b. The arc is formed so that the arced surface protrudes inward.

The projections at the other areas are not removed after the friction stir welding. When the hollow shape members are used as in the present embodiment as a car body that requires strength, if the line connecting the protruded end of the projection and the face plate is orthogonal to the face plate surface, the base area of the projection locally receives a large load, and the strength of the member is reduced. Therefore, the present embodiment employs an arced connection. In another example, the connecting surface can be sloped instead of the present arc.

Moreover, as mentioned later, the projections 15 and 25 formed at the outer surface side of the face plates become the object of detection by an optical sensor, so it is best that the connection between the protruded end of the projection and the arced surface is linear.

The rotary tool 50 comprises a large diameter portion 53 and a large diameter portion 54 formed on the axial ends of a small-diameter portion 51. Upon performing the friction stir welding, the area to be welded is sandwiched between the two large diameter portions 53 and 54, and the rotary tool 50 is rotated and moved along the longitudinal direction of the hollow shape members (along the jointline). A screw thread is provided to the outer surface of the small-diameter portion 51. A driving apparatus for rotating and moving the rotary tool 50 is positioned on the upper end of the tool 50.

The parts constituting the rotary tool 50 consists of a member including the large-diameter portion 53 and the small-diameter portion 51, and a member corresponding to the large-diameter portion 54 to be equipped to the end of the small-diameter portion. The member with the large-diameter portion 53 consists of, starting from the upper-end side, a large-diameter portion 53 having a circular outer diameter, a circular small-diameter portion 51, and a shaft portion 51c having a small diameter onto which the member 54b of the large-diameter portion 54 is fixed. The shaft portion 51c includes a pin hole 57 used for fixing the member 54b.

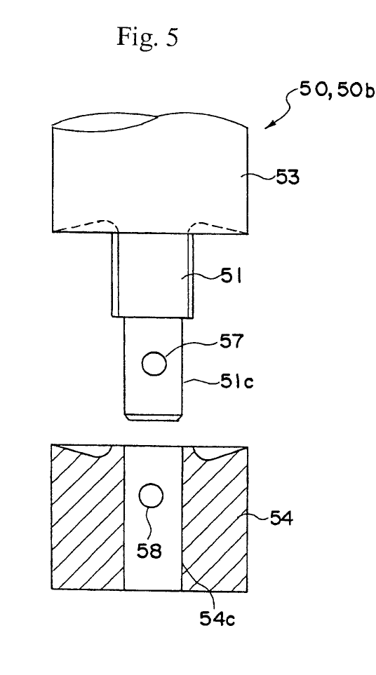

The member corresponding to the large-diameter portion 54 comprises a circular outer diameter, with a hole 54c designed to fit the shaft portion 51c, and a pin hole 58. The end surfaces of the large-diameter portions 53 and 54 facing the small-diameter portion 51 are concaved and sloped, as shown in FIG. 5. This concave is for pressing the stirred metal to the inner direction and to prevent flow of the material to the exterior.

After manufacturing the parts, the member corresponding to the large-diameter portion 54 is fit to the shaft 51c, and a knock pin 59 is inserted to the pin holes 57 and 58 so as to fix the large-diameter portion 54 to the tool.

The length L of the small-diameter portion 51 (the length from the end surface of the large-diameter portion 53 to the end surface of the large-diameter portion 54) is greater than the plate thickness t (excluding the projections 15, 16, 25, 26) of the face plates 11b and 21b (12b and 22b). However, length L is smaller than the plate thickness of the face plates 11b and 21b (12b and 22b) including the projections 15, 16, 25, 26. Since the plate thickness of the upper face plates 11b and 21b differ from the plate thickness of the lower face plates 12b and 22b, the rotary tool 50 for welding the upper plate and the rotary tool 50 for welding the lower plate have different small-diameter lengths L. The diameter D of each large-diameter portion 53 and 54 is smaller than the total width W of the two projections 15 and 25, or projections 16 and 26.

Now, the steps for welding the two hollow shape members will be explained. The two hollow shape members 10 and 20 are mounted on a bed 100, and the face plates 11b and 12b of the hollow shape member 10 is abutted against the face plates 21b and 22b of the hollow shape member 20. Thereby, the projections 28 of the face plates 21b and 22b are inserted to the recessed portions 18 of the face plates 11b and 12b. The hollow shape members 10, 20 are fixed in this manner to the bed 100. The projections 15 and 25 of the lower face plates 12b and 22b are received by the recessed portion 101 on the bed 100. The projections 15 and 25 on the upper face plates 11b and 21b are arc-welded intermittently. This is for temporarily welding the members.

At this state, the upper face plates 11b and 21b of the hollow shape members 10 and 20 are friction-stir-welded. The rotating rotary tool 50 positioned at the longitudinal end portion of the hollow shape members 10, 20 is moved toward the members, and the portion to bewelded (the abutted portion between the face plates 11b and 21b) is disposed between the two large-diameter portions 53 and 54 (the small-diameter portion 51). The abutted portion is friction-stir-welded by the movement of the rotary tool 50.

Upon friction stir welding, the central axis of the rotary tool 50 is set to be disposed at the center of depth of the recessed portion 18. According thereto, the recessed portion 18, the projection 28, and the abutted portion can be sufficiently friction-stir-welded even when the recessed portion 18 is deep or when the gap formed at the abutted portion is large.

An optical sensor positioned at the forward direction of movement of the rotary tool 50 is used to detect the projections 15 and 25 so as to guide the rotary tool 50. That is, the optical sensor detects a width W constituted of projections 15 and 25 so as to dispose the center of the rotary tool 50 to the center of depth of the recessed portion 18. The width is detected by detecting the width-direction-ends of one large projection formed of projections 15 and 25. Further, the optical sensor detects the upper surface of the projection or the upper surface of the face plate near the projection so as to compute the height of the joint region, and determines the vertical position of the rotary tool 50. Accordingly, the large-diameter portions 53 and 54 of the rotary tool 50 are positioned so as to sandwich the projecting portions at both sides of the abutting face plates.

As is already well known, the central axis of the rotary tool 50 is tilted rearward in the direction of movement of the tool 50 during the friction stir welding process. The central axis of the rotary tool 50 is tilted so that the axis of the lower large-diameter portion 54 is positioned toward the forward direction of movement than the upper large-diameter portion 53.

During friction stir welding, the rear end of the upper large-diameter portion 53 is positioned within the projections 15 and 25. What is meant by the rear end of the large-diameter portion 53 being positioned within the projections 15 and 25 is that the rear end of the large-diameter portion 53 is disposed (inserted) between the apex of the projections 15 and 25 and the outer surface (upper surface) of the face plates 11b and 21b excluding the projections 15 and 25.

On the other hand, the front end of the lower large-diameter portion 54 is positioned within the projections 16 and 26. What is meant by the front end of the large-diameter portion 54 being positioned within the projections 16 and 26 is that the front end of the large-diameter portion 54 is disposed (inserted) between the apex of the projections 15 and 25 and the outer surface (upper surface) of the face plates 11b and 21b excluding the projections 16 and 26.

Therefore, as shown in FIG. 4, a joint portion surface that is recessed from the apex of the projections 15, 25, 16 and 26 is formed to the upper and lower surfaces of the joint region. The rear end position of the large-diameter portion 53 is the criteria for the upper surface of the joint portion. The front end position of the large-diameter portion is the criteria for the lower surface of the joint portion. However, the metal rises a little at the back end of the large-diameter portion 54. FIG. 4 shows a frame format of the cross-section of the joint after the welding.

According to the above procedure, the surface of the joint portion is disposed toward the outer side than the upper and lower surfaces of the face plates 11b and 21b, so the thickness of the face plates 11b and 21b will not be reduced. In other words, even if the face plate 11b, 21b, 12b or 22b is somewhat bent vertically in the direction of movement of the rotary tool 50, merely the depth of the large-diameter portions 53 and 54 inserted to the projections 15, 16, 25 and 26 is varied, and the face plates 11b, 21b, 12b or 22b will not be damaged. According to the present embodiment, the plate thickness will not be reduced. Moreover, the present embodiment provides an easy friction stir welding method that does not require strict position management of the rotary tool 50 against the face plates. The present method is advantageous in that it does not cause design-related or function-related problems.

After welding the face plates 11b and 21b, the hollow shape members 10 and 20 are turned up-side down with the face plates 11 and 21 positioned downward, and they are fixed to the bed 100 before temporarily welding the abutted portion between the face plates 12b and 22b. Thereafter, the abutted portion between the face plates 12b and 22b is friction-stir-welded as mentioned above.

Next, the projections 15 and 25 formed to the side of the face plates that constitute the exterior of the car body (for example, 12b and 22b) are cut off so that the joint region is flush with the face plates 12b and 22b. Since the outer surface of the joint region is disposed between the face plates 12b and 22b and the apex of the projections 15 and 25, a cutting process of the joint region creates a surface flush with the face plates. The cutting can be performed for example by manually operating a grinder. Since the apex of the projections 15, 25 and the face plates 12b, 22b are connected via orthogonal lines, the amount of cutting is smaller compared to the case where the projections 15, 25 and the face plates 12b, 22b are connected via arc-like lines.

Since the inner face of the car body is covered with a decorative plate, it is not necessary to remove the projections 15 and 25 of the face plates 11b and 21b facing the interior side merely for good appearance.

Upon friction stir welding, the gap formed to the abutted region (for example, the gap between the recessed portion 18 and the projection 28, or the gap formed between the surface 17 and the surface 27) is filled by the metal constituting the projections 15, 25, 16 and 26. The excessive metal material flies away from the large-diameter portions 53 and 54. Such gap is easily formed at the abutted region because the car body is as long as approximately 20 m.

The car body 500 has a length of approximately 20 m, and the face plates 11b, 12b, 21b and 22b tend to be somewhat distorted in the direction of thickness of the hollow shape members 10 and 20. However, since the two face plates 11b and 21b (or 12b and 22b) are fit to one another by the recessed portion 18 and the projection 28, the height of the face plate 11b (12b) at the abutted end is equal to the height of the face plate 21b (22b) at the abutted end. If the surface height of the two face plates differ at the abutted region, a gap is often formed at the joint. According to the present embodiment in which the recessed portion and the projection are used to fit one face plate to the other, the friction stir welding performed thereto has less defects.

During the friction stir welding, the two face plates are sandwiched between the two large-diameter portions 53 and 54, so upon welding the face plates 11b and 21b, there is no force operating to the joint in the direction inserting the rotary tool 50 toward the face plates 12 and 22. According to the present invention, hollow shape members can be welded without deformation even if there is no support plate provided to the joint region.

By disposing a cutting blade on the outer periphery of the lower end of the large-diameter portion 53, the friction stir welding and the cutting of the projections 15 and 25 and the joint region disposed above the blade can be performed simultaneously. At a minimum, the blade removes the weld flash formed by the friction stir welding. The rotating diameter of the blade rotated by the rotation of the rotary tool 50 is set to be greater than the width W of the two projections 15 and 25. Accordingly, the projections 15 and 26 will remain after the cutting. The surface of the upper joint region is substantially flush with the projections 15 and 25. However, since the blade is provided to the rotary tool, the cutting surface is arc-shaped, as is the welded surface as shown in FIG. 4. According to the present embodiment, the weight of the hollow shape members after the weld can be reduced. This technique is disclosed in above-referenced Japanese Patent Laid-Open Publication No. 2001-047262 (EP 1057575 A2). Further, if the above cutting process removes a portion of the projections 15 and 25 of the face plates 12b and 22b, the succeeding cutting process for creating a surface flush with the face plates 12b and 22b is simplified.

A cutting blade can also be provided to the large-diameter portion 54. The position of the blade is set lower than the upper end of the large-diameter portion 54. The tilt direction of the large-diameter portion 54 against the projections 16 and 26 is opposite to the tilt direction of the large-diameter portion 53 against the projections 15 and 25, so the position of the blade in the perpendicular direction is determined so as not to cut the projections 16 and 26 before the welding. The blade should be disposed so as to cut the weld flash generated by the friction stir welding, that is, below the apex of the projections 16 and 26. Since the rotary tool 50 is tilted, the large-diameter portion 54 can also be described as the front-side large-diameter portion in the direction of movement of the rotary tool. The swarf generated by the cutting and the swarf generated by the friction stir welding are removed by the air blown from one end of the hollow shape members.

According to the above embodiment, a recessed portion 18 is formed to each face plate 11b and 12b of the hollow shape member 10, and a projection 28 is formed to each face plate 21b and 22b of the hollow shape member 20. However, it is possible to provide a recessed portion 18 to the face plates 11b and 22b, and to provide a projection 28 to the face plates 12b and 21b.

The embodiment of FIG. 7 will now be explained. The upper surface (the apex surface) of the projections 15 and 25 detected by the optical sensor 35 is provided with second projections 31 and 32. The height of the second projections 31 and 32 is approximately 1 mm. The total width W2 of the two projections 31 and 32 is approximately 15 mm. The optical sensor 35 detects the second projections 31 and 32 so as to guide the rotary tool 50 thereto. The second projections 31 and 32 will disappear by the friction stir welding.

In order to detect the width and height of the projection with high accuracy, it is necessary to set the distance H2 between the optical sensor 35 and the projections 31, 32 equal to or less than a value determined for the sensor (substantially equal to or below the focal length of the sensor). The present embodiment provides the second projections 31 and 32, which reduce the width W2, brings the distance H2 within the predetermined range, and enables highly accurate detection. Therefore, the present embodiment allows the width W of the projections 15 and 25 to be increased. This is advantageous because if the depth of the recessed portion 18 is large and the width of the joint region should be increased accordingly, the width of the projections 15 and 25 should also be widened in order to perform the weld using a tool 50 having two large-diameter portions 53 and 54. However, if the width W is increased, the distance H2 between the sensor and the projections should also be increased accordingly. As a result, the distance H2 exceeds the predetermined value, and the position can no longer be detected accurately. However, accurate detection is still possible if the second projections 31 and 32 are provided to the face plates. It is also possible to provide a second projection to only one of the two projections (15 or 25).

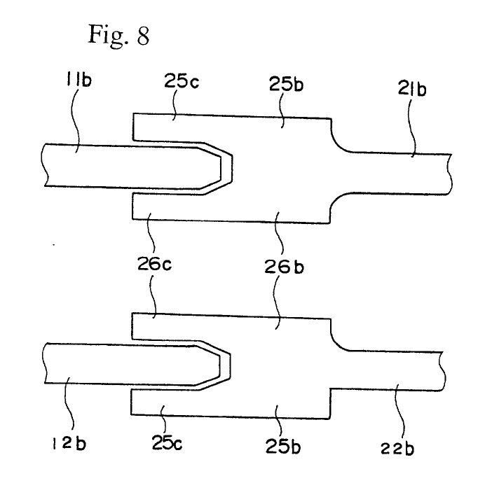

The embodiment of FIG. 8 will now be explained. The end portion of the face plates 11b and 12b are not provided with a projection, but instead, is substantially plate-shaped. Both sides of the end of face plates 21b and 22b of the hollow shape member 20 are provided with projections 25b and 26b. The projections 25b and 26b protrude toward the direction of thickness of the face plates 21b and 22b, and is also protruded beyond the end surface of the face plates along the face plates 21b and 22b. These protruded portions are called protruded blocks 25c and 26c. The area between the two protruded blocks 25c and 26c is formed as a recessed portion into which the face plate 11b (12b) is inserted. The width of the recessed portion and the shape of the tip of the face plates 11b and 12b are designed so that the face plates 11b and 12b are easily inserted to the recessed portion. The depth of the recessed portion is deeper than that of the embodiment of FIG. 2.

The width of the projections 25b and 26b including the protruded blocks 25c and 26c is similar to the above-explained width W. The center of the rotary tool 50 is disposed at the bottom (depth) surface of the recessed portion. The bottom surface of the recessed portion is disposed substantially at the center of width of the projections 25b and 26b including the protruded blocks 25c and 26c. The bottom surface of the recessed portions and the end surfaces of the face plates 11b and 12b are substantially orthogonal to the face plates. The height of the projections 25b and 26b are similar to that of the projections 15, 16, 25 and 26.

Although the protruding blocks 25c and 26c are not indispensable, these blocks contribute to realizing a good weld.

It is also possible to provide a recessed portion to the face plates 11b and 22b, and to provide projections to the face plates 21b and 12b.

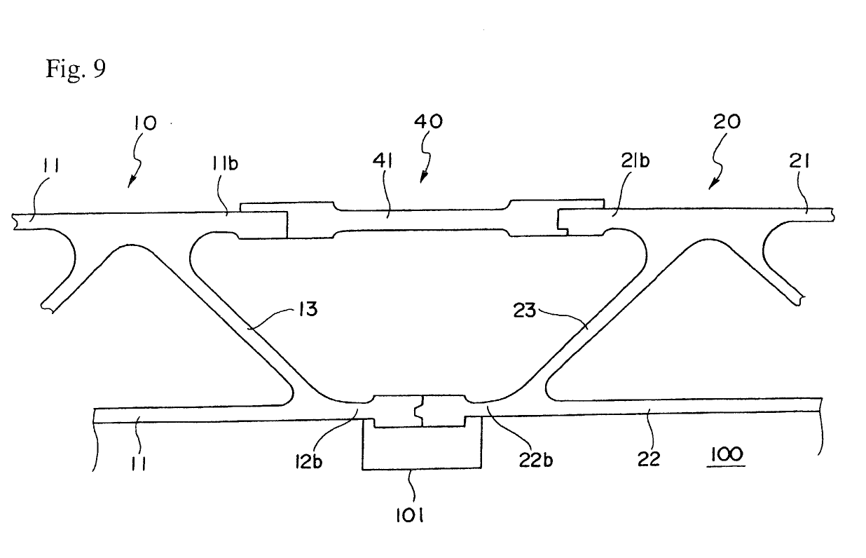

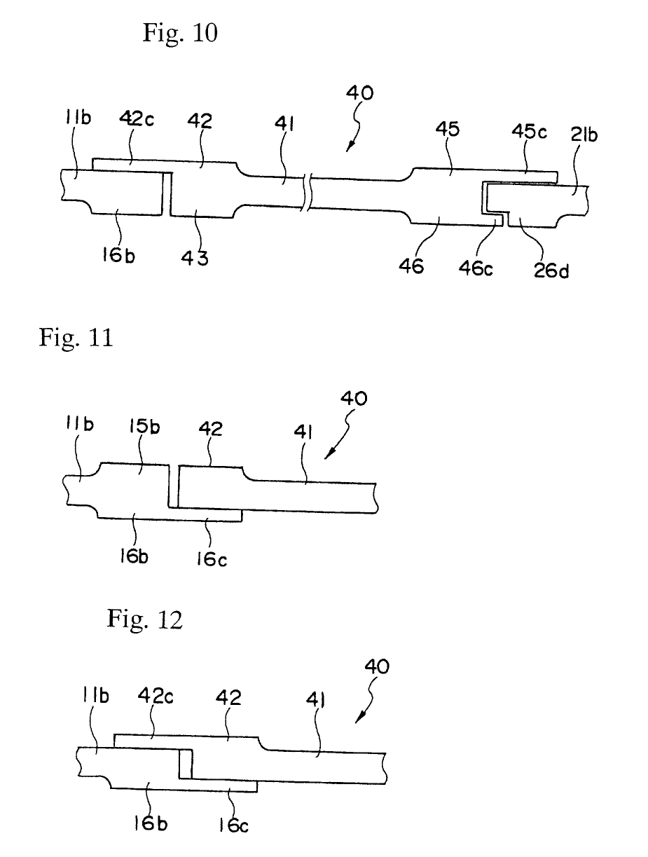

The embodiment shown in FIGS. 9 and 10 will now be explained. This embodiment involves welding both sides of the hollow shape members from one side of the members. The end portion of the face plate 12b is abutted against the end portion of the face plate 22b, and is fit to one another. The structure of the ends of the face plates 12b and 22b is similar to the embodiment of FIG. 2. The face plate 12b (22b) is protruded toward the end than the upper face plate 11b (21b). The face plate 11b and the face plate 21b are welded via a connecting member 40. The connecting member 40 is provided with projections formed to both ends of a plate 41.

There is no projection formed to the upper surface of the face plate 11b at the end thereof. However, the lower surface is provided with a projection 16b. A projection 42 is provided to the upper surface of the connecting member 40 at one end thereof. The projection 42 protrudes upward, and also protrudes toward the face plate 11b from the end surface of the plate 41 along the direction of the plate 41. The protruding block 42c of the projection 42 is mounted on (superposed on) the face plate 11b. A projection 43 is formed to the lower surface of the connecting member 40 at one end thereof. The end surface of the face plate 11b and projection 16b is abutted against the end surface of the plate 41 and projection 43.

The center of the rotary tool 50 is disposed on the center of width of the projection 42 including the protruding block 42c. In other words, the center of the rotary tool 50 is disposed on the end surface of the face plate 11b and projection 16b and the end surface of the plate 41 and projection 43 (the abutting plane). The width of the projection 42 including the protruding block 42c is greater than the diameter of the large-diameter portion 53. The end surfaces of the face plate 11b and projection 16b and the plate 41 and projection 43 is substantially orthogonal to the face plate 11b and the plate 41. The height of the projection 16b, portion 42 and portion 43 is equal to the height of projections 15, 16, 25 and 26.

Projections 45 and 46 are provided to the other end of the connecting member 40. Protruding blocks 45c and 46c extend beyond the end of projections 45 and 46 along the plate 41. The length of the protruding block 45c is equal to the width of the projection 45. The length of the protruding block 46c is short. The space between the protruding blocks 45c and 46c constitutes a recessed portion. The end surface of the plate 41 is disposed at the center of width of the projection 45 including the protruding block 45c. The face plate 21b includes a projection 26d formed to the lower surface thereof that is abutted against the end of the protruding block 46c. The total width of the projection 26d and protruding block 46c is equal to the width of the projection 46.

According to this structure, the hollow shape members 10 and 20 are fixed on the bed 100 with the face plates 12b and 22b positioned downward, and the abutted face plates 12b and 22b are temporarily welded together. Next, the members are friction-stir-welded from the side of the upper face plates 11b and 21b (from above) with the rotary tool 50. The size of the recessed portion 101 of the bed 100 is determined based on the size of the large-diameter portion 54.

Next, the connecting member 40 is assembled onto the face plates 11b and 21b. That is, the connecting member 40 is moved in the width direction, and the end portion of the face plate 21b is inserted between the protruding blocks 45c and 46c. Next, the other end of the connecting plate is lowered so as to place the protruding block 16c onto the face plate 11b. Since both ends of the connecting member 40 are supported by face plates 11b and 21b, the member 40 will not fall. Since the lower protruding block 46c is short, the face pate 21b can be inserted with ease. Next, both ends of the connecting member 40 are temporarily welded to the face plates 11b and 21b.

The connecting member 40 has no ribs and the like, so it easily bends in the thickness direction along the longitudinal direction thereof, making the assembly of the members difficult. Therefore, the length of the connecting member 40 is designed to be sufficiently shorter than the hollow shape members 10 and 20 (that have a length of approximately 20 m, equal to the length of the car body). For example, the length of the connecting member 40 is set to a couple of meters. According to this design, plural connecting members 40 are arranged along the joint line of a pair of hollow shape members. The joint between a connecting member 40 and another connecting member 40 is temporarily welded by arc welding. The welding is performed at the abutting portion between the projections 42, 42c, 45, and 45c of one connecting member 40 and the projections 42, 42c, 45, and 45c of the other connecting member 40. There is no need to weld the abutting portion between the plate 41 and another plate 41. In other words, only the area where the large-diameter portion 53 of the rotary tool 50 travels must be welded. Welding is performed so that there is no gap formed to the abutting region. That is, projections 42 and 42c (45 and 45c) should continuously be disposed at the abutting region. As a result, fewer defects are found in the weld at the abutting region.

Next, the abutting regions between the connecting member 40 and the face plates 11b and 21b are friction-stir-welded. Either both ends of the connecting member 40 can be welded simultaneously, or one end can be welded before welding the other end.

In the case where one end is welded before welding the other end, the abutting region between the face plate 11b and the connecting member 40 is welded at first, and the abutting region between the face plate 21b and the connecting member 40 is welded thereafter. According to this example, even if the connecting member 40 is deformed by the heat generated by the first friction stir welding which may cause the unwelded side of the member (the side of the projections 25b an 26b) to rise, such undesired movement is prevented since the unwelded side is fit to the other member. Accordingly, a good weld is achieved.

Next, the outer side of the face plates 12b and 22b is smoothed, and this side is used as the exterior side of the car body.

The embodiment of FIG. 11 will now be explained. This drawing shows the joint between the face plate 11b and the connecting member 40. In comparison to the embodiment of FIG. 8, the members are placed up-side down in the present embodiment.

The embodiment of FIG. 12 will now be explained. The drawing shows the joint between the face plate 11b and the connecting member 40. There is no projection disposed on the upper surface of the face plate 11b at the end portion thereof. A projection 16b is formed to the lower surface thereof. The projection 16b protrudes downward, and extends toward the connecting member 40 beyond the end surface of the face plate 11b along the plate 11b. The lower surface of one end of the connecting member 40 is superposed on a protruding block 16c of the projection 16b. On the upper surface of one end of the connecting member 40 is formed a projection 42 similar to the preceding embodiments. A protruding block 42c of the projection 42 is superposed on the face plate 11b. However, even though both the upper and lower protruding blocks 42c and 16c are superposed on the other member, respectively, substantially only one of the two protruding blocks contacts the other member.

According to the present embodiment, both the members constituting the joint is provided with a projection that overlies on the other member.

In each of the embodiments shown in FIGS. 10, 11 and 12, the joints shown in FIG. 2 and FIG. 7 can be applied as the joint between the face plate 21 band the connecting member 40. Further, the joint shown in FIG. 8 can be applied as the joint between the face plate 12b and the face plate 22b. Moreover, the joint between the face plate 11b and the connecting member 40 as shown in FIG. 10, FIG. 11 or FIG. 12, or the joint between the face plate 21b and the connecting member 40 as shown in FIG. 10, can be applied to the joint of FIG. 1. Moreover, the connecting members 13 and 23 disposed at the end of the hollow shape members 10 and 20 can be positioned orthogonal to the face plates 11b, 12b, 21b and 22b.

The joint of each embodiment can be applied as the joint between various members.

The technical scope of the present invention is not restricted by the terms used in the claims or in the summary of the present invention, but is extended to the range in which a person skilled in the art could easily substitute based on the present disclosure.

According to the present invention, a good weld is realized upon friction-stir-welding members using a rotary tool having two large-diameter portions.

Moreover, the present invention provides an easy friction stir welding method suitable for welding long plates.

Even further, according to the present invention, a good weld is realized by guiding the rotary tool accurately to the desired position upon performing the friction stir welding.

What is claimed is:

1. A friction stir welding method comprising:
abutting an end of a first plate against an end of a second plate;
wherein upon abutment, projections are disposed on both surfaces of said abutted portion, constituted either by said end of said first plate, said end of said second plate, or both said ends of said first and second plates; and
rotating and moving a rotary tool having two large-diameter portions provided to both ends of a small-diameter portion along said abutted portion with said projections on both surfaces sandwiched between said two large-diameter portions of said rotary tool.

2. A friction stir welding method according to claim 1, wherein:
said ends of said first and second plates are each provided with projections protruding to both surfaces of said plates; and
said first and second plates are abutted against each other.

3. A friction stir welding method according to claim 2, wherein:
a second projection is formed to the end surface of said first plate at the abutted portion, and a recessed portion for receiving said second projection is formed to the end surface of said second plate; and
said second projection is inserted to said recessed portion when friction stir welding said inserted portion.

4. A friction stir welding method according to claim 1, wherein:
said end of said first plate protrudes to both surfaces of said first plate, and at the same time, includes projections each extending toward said second plate along said first plate, with a recessed portion existing between said projections formed to both surfaces of said first plate;
said end of said second plate is inserted to said recessed portion; and
friction stir welding is performed thereto.

5. A friction stir welding method according to claim 1, wherein:
upon abutment, projections are formed to both surfaces at said end being abutted of at least said first plate, with a recessed portion existing between said two projections;
said end of said second plate is inserted to said recessed portion; and
friction stir welding is performed to said inserted portion.

6. A friction stir welding method according to claim 1, wherein:
said abutting step creates a hollow state; and
air is blown from one end of the hollow space toward the other end after the friction stir welding process.

7. A friction stir welding method according to claim 1, wherein:
the friction stir welding is performed using a rotary tool having blades provided to the outer periphery of each of said two large-diameter portions, by which the weld flash created by the friction stir welding is removed.

8. A friction stir welding method comprising:
abutting two face plates of a first hollow shape member against two face plates of a second hollow shape member, respectively;
wherein upon abutment, projections are disposed on both surfaces of said abutted portions, constituted either by said ends of each face plate of said first hollow shape member, by said ends of each face plate of said second hollow shape member, or by both; and
rotating and moving a rotary tool having two large-diameter portions provided to both ends of a small-diameter portion along said abutted portion with said projections on both surfaces sandwiched between said two large-diameter portions of said rotary tool, with either one side or both sides of said hollow shape members being subject to welding.

9. A friction stir welding method according to claim 8, wherein:
upon abutment, projections are disposed on both surfaces of at least said first plate at said end being abutted, with a recessed portion existing between said two projections;
said end of said second plate is inserted to said recessed portion; and
friction stir welding is performed to said inserted portion.

10. A friction stir welding method comprising:
abutting a first face plate of a first hollow shape member against a first face plate of a second hollow shape member, respectively;
wherein upon abutment, projections are disposed on both surfaces of said abutted portion, constituted either by said end of the face plate of said first hollow shape member, by said end of the face plate of said second hollow shape member, or by both;
rotating and moving a rotary tool having two large-diameter portions provided to both ends of a small-diameter portion along said abutted portion with said projections on both surfaces sandwiched between said two large-diameter portions of said rotary tool;
superposing a connecting member on and abutting the same against a second face plate of said first hollow shape member and a second face plate of said second hollow shape member;
wherein upon abutment, projections are disposed on both surfaces of the abutted portion, constituted either by said end of the second face plate of said first hollow shape member, by an end of said connecting member, or by both;
further upon abutment, projections are disposed on both surfaces of the abutted portion, constituted either by said end of the second face plate of said second hollow member, by an end of said connecting member, or by both; and
rotating and moving a rotary tool having two large-diameter portions provided to both ends of a small-diameter portion along said abutted portion with said projections on both surfaces sandwiched between said two large-diameter portions of said rotary tool, with either the abutted portion between said first hollow shape member and said connecting member, or both the abutted portion between said first hollow shape member and said connecting member and the abutted portion between said second hollow shape member and said connecting member being subject to welding.

11. A friction stir welding method according to claim 10, wherein
upon abutting said first face plates, projections are disposed on both surfaces of at least one first face plate at said end being abutted, with a recessed portion existing between said two projections;
said end of the other first face plate is inserted to said recessed portion; and
friction stir welding is performed to said inserted portion.

12. A friction stir welding method according to claim 10, wherein
upon abutting said connecting member with said first hollow member and said second hollow member, at least at one abutting region, projections are disposed on both surfaces of at least the end of said connecting member or the end of the face plate being abutted thereto, with a recessed portion existing between said two projections;
the member abutting against said recessed portion is inserted to said recessed portion; and
friction stir welding is performed to said inserted portion.

13. A friction stir welding method according to claim 10, wherein
upon abutting said connecting member with said first hollow member and said second hollow member, at one abutting region, projections are disposed on both sides of at least the end of said connecting member or the end of the face plate being abutted thereto, with a recessed portion existing between said two projections;
the member abutting against said recessed portion is inserted to said recessed portion;
the other abutting region is not inserted to a recessed portion;
friction stir welding is performed to said other abutting region; and
thereafter, friction stir welding is performed to said inserted portion.

14. A friction stir welding method comprising:
abutting a first face plate of a first hollow shape member against a first face plate of a second hollow shape member;
friction stir welding said abutted region from a second face plate side;
superposing a plurality of connecting members shorter than said first and second hollow shape members to a second face plate of said first hollow shape member and a second face plate of said second hollow shape member along said first and second hollow shape members; and
welding the first hollow shape member and the connecting member, and friction stir welding the second hollow shape member and said connecting member.

15. A friction stir welding method according to claim 14, wherein:
after superposing said connecting members on said first and second hollow shape members, welding the area near the superposed portion between said connecting members; and
friction stir welding the superposed portion thereafter.

16. A friction stir welding method comprising:
abutting the end of a first plate against the end of a second plate;
wherein upon abutment, a projection is disposed on one surface of said abutted portion, constituted either by the end of said first plate, by the end of said second plate, or by both, said projection including a second projection; and
detecting said second projection and guiding an inserted rotary tool to said abutted portion.

17. A panel structure characterized in that:
an abutted portion between two panels is friction-stir-welded;
projections are disposed on both surfaces of said plate at the friction-stir-welded portion;
the line connecting one surface of said plate and the apex of one of said projections is substantially orthogonal to the thickness direction of said plates; and
the line connecting the other surface of said plate and the apex of the other projection is either arced or slanted.

18. A panel structure characterized in that:
two face plates of a first hollow shape member are abutted against and friction-stir-welded to two face plates of a second hollow shape member, respectively; and
projections are disposed on both surfaces of said face plates at each of said friction-stir-welded portions.

19. A panel structure characterized in that:
two face plates of a first hollow shape member are abutted against and friction-stir-welded to two face plates of a second hollow shape member, respectively;
at the portion where first face plates are friction-stir-welded, thewelded surface positioned at the outer surface side of said hollow shape member is substantially flush with the face plate;
at the portion where said first face plates are friction-stir-welded, the surface positioned at the inner side of said hollow shape member is provided with a projection; and
at the portion where second face plates are friction-stir-welded, projections are provided to both surfaces of said face plate.

20. A panel structure according to claim 19, wherein
the line connecting the apex of each projection and each face plate is either arced or slanted.

21. A panel structure characterized in that:
the abutting portion between a first face plate of a first hollow shape member and a first face plate of a second hollow shape member is friction-stir-welded;
a second face plate of said first hollow shape member and a second face plate of said second hollow shape member are friction-stir-welded via a connecting member;
said friction stir welding is performed to the abutted portions between said second face plates and said connecting member; and
projections are disposed on both surfaces of said face plates at the friction-stir-welded portions, respectively.

22. A panel structure characterized in that:
the abutted portion between a first face plate of a first hollow shape member and a first face plate of a second hollow shape member is friction-stir-welded;
a second face plate of said first hollow shape member and a second face plate of said second hollow shape member are friction-stir-welded via a connecting member;
said friction stir welding is performed to the abutted portions between said second face plates and said connecting member;
in the area where said first face plates are friction-stir-welded, the welded surface facing the outer side of said hollow shape members is substantially flush with said first face plates;
in the area where said first face plates are friction-stir-welded, the surface facing the inner side of said hollow shape members is provided with a projection; and
in the area where said second face plates are friction-stir-welded, projections are formed to both surfaces of said second face plates.

23. A panel structure according to claim 22, wherein
the line connecting the apex of each projection and the surface plates, respectively, is either arced or slanted.

24. A member for friction stir welding, characterized in that:
projections are disposed on both surfaces at an end portion of a plate, said projections each protruding toward the thickness direction of said plate and further protruding beyond said end portion along the surface of said plate;
a recessed portion exists between said projections formed to both surfaces of said plate at the end portion of said plate;
the bottom surface of said recessed portion is substantially disposed near the center of width of at least one of said projections; and
friction stir welding is performed to said end portion.

25. A member for friction stir welding according to claim 24, wherein
the bottom surface of said recessed portion is substantially disposed near the center of width of the projections formed to both surfaces of said plate.

26. A member for friction stir welding according to claim 24, wherein
the length of one projection protruding along the surface of said plate is longer than that of the other projection.

27. A member for friction stir welding, characterized in that:
a first projection is provided to one surface of a plate at one end thereof that protrudes toward the thickness direction of said plate;
a second projection is provided to the other surface of said plate at said end thereof that protrudes toward the thickness direction of said plate and extends beyond said end along said other surface of said plate; and
friction stir welding is performed to said end portion.

28. A member for friction stir welding according to claim 27, wherein:
the end surface at said one end of said plate is substantially orthogonal to said plate along the thickness direction of said plate.

29. A member for friction stir welding according to claim 27, wherein:
the distance between the end surface of said one end of the plate to the end of said first projection on the other end thereof is substantially equal to the distance from the end surface of said one end of the plate to the end of said second projection on the other end thereof; and
the end surface of said one end of the plate is substantially disposed at the center of width of said second projection.

30. A member for friction stir welding, characterized in that:
first projections protruding in the thickness direction of a plate are formed to both surfaces of a first end of a plate, respectively;
a second projection protruding in the thickness direction of said plate is formed to one surface at a second end of said plate, said second projection further protruding beyond the second end side of said plate along said one surface; and
friction stir welding is performed to said first and second ends of said plate.

31. A member for friction stir welding according to claim 30, wherein:
a recessed portion is provided to one end surface of said plate between the apex of each of said first projections formed to both surfaces of said plate; and
the bottom surface of said recessed portion is substantially disposed at the center of width of said first projection.

32. A member for friction stir welding according to claim 30, wherein:
the end surface of said second end of said plate is substantially disposed at the center of width of said second projection.

33. A member for friction stir welding, characterized in that:
first projections protruding in the thickness direction of a plate are formed to both surfaces at a first end of a plate, respectively;
a second projection protruding in the thickness direction of said plate is formed to one surface at a second end of said plate; and
friction stir welding is performed to said first and second ends of said plate.

34. A member for friction stir welding, characterized in that:
projections protruding in the thickness direction of a plate are formed to both surfaces at an end of a plate;
the line connecting the apex of the projection formed to a first surface of said plate and said first surface is substantially orthogonal to said plate;
the line connecting the apex of the projection formed to a second surface of said plate and said second surface is either arced or slanted; and
friction stir welding is performed to said end portion.

35. A hollow shape member comprising:
two substantially parallel face plates;
a connecting plate for connecting said face plates;
wherein at least one face plate comprises projections disposed on both surfaces at one end of said plate that protrude toward the thickness direction of said face plate and further protrude beyond said end along the surface of said face plate;
a recessed portion is provided at the end surface of said plate between said two projections;
the bottom surface of said recessed portion is substantially disposed near the center of width of at least one of said projections; and
friction stir welding is performed to said end.

36. A hollow shape member according to claim 35, wherein:
the bottom surface of said recessed portion is substantially disposed near the center of width of both said projections.

37. A hollow shape member according to claim 35, wherein
the length of one projection protruding along the surface of said plate is longer than that of the other projection.

38. A hollow shape member comprising:
two substantially parallel face plates;
a connecting plate for connecting said face plates;
wherein at least one face plate comprises a first projection disposed on a first surface at one end of said face plate protruding in the thickness direction of said plate;
a second projection is disposed on the second surface at said end of said face plate protruding in the thickness direction of said plate and further protruding beyond said one end along the second surface; and
friction stir welding is performed to said end.

39. A hollow shape member according to claim 38, wherein:
said first projection is disposed on the outer surface side of said hollow shape member.

40. A hollow shape member according to claim 38, wherein:
the distance between the end surface of said one end of said face plate to the end of said first projection on the other end thereof is substantially equal to the distance between the end surface of said one end of the face plate to the end of said second projection on the other end thereof; and
the end surface of said one end of said face plate is substantially disposed at the center of width of said second projection.

41. A hollow shape member comprising:
two substantially parallel face plates;
a connecting plate for connecting said face plates;
wherein at least one face plate comprises at one end thereof a projection formed to a first surface that protrudes in the thickness direction of said plate and further protrudes beyond said end of said face plate along said first surface; and
friction stir welding is performed to said end.

42. A hollow shape member according to claim 41, wherein:
said projection is provided to the inner side of said hollow shape member.

43. A hollow shape member according to claim 41, wherein:
the end of said one face plate is substantially disposed at the center of width of said projection.

44. A hollow shape member comprising:
two substantially parallel face plates;
a connecting plate for connecting said face plates;
wherein both plates are provided with projections disposed on both surfaces of one end thereof, respectively, that protrude in the thickness direction of said face plate;
the line connecting the apex of the projection facing the outer side of one face plate and the outer surface of said one face plate is substantially orthogonal to said plate;
the line connecting the apex of the other projections and the other surfaces is either arced or slanted; and
friction stir welding is performed to said end.

45. A member for friction stir welding, comprising:
a first projection formed to an end of a plate that protrudes in the thickness direction of said plate; and
a second projection formed within the range of said first projection that protrudes in said thickness direction.

46. A member for friction stir welding, comprising a first member and a second member;
wherein an end of said first member is capable of being abutted against an end of said second member; and
upon abutment, either said end of said first plate, said end of said second plate, or both said ends of said first and second plates constitute projections disposed on both surfaces of the abutted region.

47. A hollow shape member comprising a first hollow shape member and a second hollow shape member;
wherein an end of each face plate of said first hollow shape member is capable of being abutted against an end of each face plate of said second hollow shape member; and
upon abutment, either said ends of the face plates of said first hollow shape member, said ends of the face plates of said second hollow shape member, or both said ends of face plates of said first and second hollow shape members constitute projections disposed on both surfaces of the abutted region.

48. A hollow shape member comprising a first hollow shape member, a second hollow shape member, and a connecting member;
wherein an end of a first face plate of said first hollow shape member is capable of being abutted against an end of a first face plate of said second hollow shape member;
a second face plate of said first hollow shape member is capable of being abutted against one end of said connecting member, and a second face plate of said second hollow shape member is capable of being abutted against the other end of said connecting member; and
upon abutting said members, respectively, either one member, the other member, or both members constituting the abutted region forms projections disposed on both surfaces of the abutted region.
